(19) United States
(12) Patent Application Publication
(10) Pub. No.: US 2026/0078005 A1
(43) Pub. Date: Mar. 19, 2026

(54) METHOD FOR CONTROLLABLY PREPARING NANOSCALE ULTRATHIN GRAPHDIYNE AND DERIVATIVE THEREOF

(71) Applicant: Nankai University, Tianjin (CN)

(72) Inventors: Huan WANG, Tianjin (CN); Tiantian LU, Tianjin (CN)

(21) Appl. No.: 19/318,721

(22) Filed: Sep. 4, 2025

(30) Foreign Application Priority Data
Sep. 14, 2024 (CN) 202411289672.9

(51) Int. Cl. C01B 32/15

(52) U.S. Cl. CPC C01B 32/15; C01P 2002/72; C01P 2002/82; C01P 2004/03; C01P 2004/04

(57) ABSTRACT

Disclosed is a method for controllably preparing nano-scale ultrathin graphdiyne and a derivative thereof. The method comprises the following steps of: mixing and ball-milling a substance A and a substance B to obtain mixed powder, wherein the substance A is a copper-containing salt, and the substance B is a salt which is insoluble in acetone and pyridine, soluble in water or acid and indecomposable within 200° C.; putting the mixed powder into a closed heating environment, heating the mixed powder at 200-450° C., cooling the mixed powder to room temperature, then dropwise adding an acetone solution containing a monomer of graphdiyne or a derivative thereof, maintaining the temperature for 1-2 days, and then cooling the mixture to room temperature; and then, soaking the powder with diluted hydrochloric acid for 1-3 days, followed by suction filtration, and freeze-drying to obtain a nano-scale ultrathin film of graphdiyne and a derivative thereof.

### CROSS REFERENCE TO RELATED APPLICATIONS

This application claims foreign priority of Chinese Patent Application No. 202411289672.9, filed on Sep. 14, 2024 in the China National Intellectual Property Administration, the disclosures of all of which are hereby incorporated by reference.

### TECHNICAL FIELD

The present invention belongs to the field of nano-carbon material preparation, and is particularly a method for controllably preparing nano-scale ultrathin graphdiyne and a derivative thereof.

### BACKGROUND OF THE PRESENT INVENTION

Carbon materials have the advantages of environmental friendliness, low cost, good conductivity, good compatibility, easy preparation, and the like, and are widely used in new energy fields such as electrocatalysis and energy storage. Carbon material families mainly comprise graphite, graphene, fullerene, diamond, and the like. Graphdiyne, first developed by Chinese scientists in 2010, is different from classical carbon materials in configuration, wherein acetylene bonds are uniformly introduced into a carbon skeleton. On the premise of ensuring conductivity, the electron cloud density of the carbon skeleton is adjusted. The uniform acetylene bonds bring rich physical and chemical properties to the graphdiyne, and there are novel discoveries in physical semiconductor sensing, new-type battery energy storage, electrocatalysis, biological research, and other aspects. In addition, a bottom-up synthesis method can achieve the preparation of various derivatives. After continuous research by researchers all over the world, graphdiyne families have been gradually developed with a wide variety, which may be designed according to needs, so as to satisfy a variety of application researches.

The graphdiyne is a two-dimensional layered carbon material, and it is always a difficult point to obtain a thin-layer or few-layer structure of the graphdiyne. It is easy to obtain a micron-scale or 1-100 nm nano-scale graphdiyne film by conventional preparation methods, and it is difficult to obtain the few-layer/thin-layer structure of the graphdiyne in batches. At present, reported methods for preparing few-layer graphdiyne mainly refer to the graphene stripping method, and the introduction of intercalated oxygen functional groups through strong oxidation is conductive to layering. However, different from an alkene double bond, an alkyne triple bond is easy to react under the strong oxidation, which results in a reduction in the content of alkyne bond. Meanwhile, a variety of oxygen-containing functional groups may also be introduced during the strong oxidation, and are difficult to be removed, which will affect subsequent further modification and application. Therefore, it is of great significance to develop an optimized preparation method to obtain intrinsic few-layer graphdiyne.

### SUMMARY OF THE PRESENT INVENTION

The present invention aims to overcome the defects in the prior art, and provide a method for preparing nano-scale ultrathin graphdiyne and a derivative thereof. Based on a strategy of controllable expansion of copper substrate, an intrinsic thin-layer graphdiyne film and a thin-layer graphdiyne derivative with a uniform mass and a thickness of about 2 nm are prepared in batches from bottom to top by a hard template method. Compare with the existing methods for preparing thin-layer graphdiyne, the present invention can obtain the intrinsic thin-layer graphdiyne without other functional groups, and the method is suitable for preparing films of various graphdiyne derivatives. Compared with an oxidation stripping method, the present invention has the advantages of low cost, simple process and controllable quality.

The technical solution used in the present invention to solve the above technical problems is as follows.

The present invention provides a method for controllably preparing nano-scale ultrathin graphdiyne and a derivative thereof, which comprises the following steps:
(1) mixing and ball-milling a substance A and a substance B to obtain mixed powder of the substance A and the substance B, and uniformly dispersing the substance A on a surface of the substance B, wherein the substance A is a copper-containing salt, and the substance B is one or more of sodium chloride, potassium chloride, sodium sulfate and potassium sulfate;
(2) putting the mixed powder into a closed heating environment, heating the mixed powder to 200-450° C. in an atmosphere of inert gas and hydrogen, maintaining hydrogen introduction and the heating temperature for 2-4 hours, and then cooling the mixed powder to room temperature;
(3) adding the mixed powder into a container, adding a solvent, then dropwise adding an acetone solution containing a monomer of graphdiyne or a derivative thereof, stirring the mixture at 50-180° C. until finishing dropwise adding, maintaining the temperature for 1-2 days, and then cooling the mixture to room temperature; and
(4) pouring out a liquid in the container after the reaction, washing the powder, then soaking the powder with dilute hydrochloric acid for 1-3 days, carrying out suction filtration with deionized water, collecting a filter cake, and freeze-drying the filter cake to obtain a nano-scale ultrathin graphdiyne film.

Further, in the step (1), a mass ratio of the substance A to the substance B is 0.5 to 20:100 (preferably 5:100).

Further, in the step (1), the substance A is one or more of copper nitrate, copper chloride, copper acetate and copper sulfate, with or without water of crystallization.

Preferably, in the step (1), when the substance A and the substance B are mixed and ball-milled, an overall ball-milling time is not less than 3 hours, and the obtained mixed powder needs to be sieved, so as to ensure uniform particles and satisfy 200-mesh sieving.

Preferably, in the step (1), the obtained solid powder is stored in a dry environment, so as to prevent copper from being oxidized again and avoid agglomeration.

Further, in the step (2), a tube furnace is used as the closed heating environment. The inert gas is nitrogen or argon, preferably the argon.

Further, in the step (2), a heating rate from room temperature to 200-450° C. is 3-10° C./min, preferably 5° C./min. The temperature should be selected to ensure that the substance B will not be decomposed, and copper may be reduced at a temperature above 200° C.

Further, in the step (2), a gas flow ratio of the hydrogen to the inert gas is 1:3 to 1:1. Preferably, 40-100 sccm hydrogen is mixed with 120-300 sccm argon. Further preferably, 50 sccm hydrogen is mixed with 150 sccm argon.

Further, in the step (2), a reduction time of the mixed powder is 2-4 hours, which may be adjusted according to an amount of the mixed powder added. The mixed powder is pink after reduction, and should be used immediately or stored in a dryer/glove box, thereby avoiding prolonged exposure to humid air to prevent reoxidation.

Further, in the step (3), a mass ratio of the powder to the monomer of the graphdiyne or the derivative thereof is 100:0.5 to 100:3.

Further, in the step (3), the solvent is a mixed solvent of acetone, pyridine and tetramethylethylene diamine prepared according to a volume ratio of 100:5:1. Preferably, in the step (3), an amount of acetone added in advance and an amount of acetone in which hexaalkynyl benzene was dissolved are calculated together into the ratio of 100:5:1. For example, 50 mL of acetone, 5 mL of pyridine and 1 mL of tetramethylethylene diamine are preferably added into a three-necked flask in advance, and the 50 mL of acetone is used for dissolving the hexaalkynyl benzene and dropwise added into the system.

Further, in the step (3), 1,3,5-trialkynyl benzene, 1,3,5-triethynyl-2,4,6-trifluorobenzene or other graphdiyne derivative monomers may be polymerized to obtain ultrathin nano-scale graphdiyne derivatives with different structures instead of the hexaalkynyl benzene.

Further, in the step (3), the monomer solution is controlled to be dropwise added within 2 hours. After the dropwise addition, the stirring may be stopped.

Further, in the step (4), the powder is washed with N,N-dimethylformamide and acetone for 2-3 times respectively, wherein the power is washed with the acetone for the last time, and then the powder is dried at room temperature.

Further, in the step (4), a concentration of the dilute hydrochloric acid selected is 0.5-1 M, a soaking time is not less than two days, and the power is placed under an open condition to facilitate the oxidation of copper.

Further, in the step (4), the power is washed with ionized water until a pH value of the system is 7, and the filter cake is collected and freeze-dried at −20° C. to −60° C. to remove remaining water. High-temperature drying is easy to cause material agglomeration, which destroys micro-morphology, so that the high-temperature drying should be avoided.

Compared with the prior art, the present invention has the beneficial effects as follows:
(1) According to the present invention, based on a strategy of controllable expansion of copper substrate, an intrinsic few-layer nano-scale graphdiyne structure is innovatively prepared by regulating a monomer input ratio, and a polymerization monomer is changed, so that various graphdiyne derivatives with a few-layer structure are prepared.
(2) According to the present invention, based on a hard template growth strategy, a soluble cheap and stable salt crystal is selected as a template, which effectively achieves the controllable expansion and simple removal of growth substrate.
(3) According to the present invention, a proportion of copper loaded and input amounts of the mixed powder and the monomer are regulated to achieve the controllable preparation of nanostructures with different growth thicknesses, which may be as low as 1 nm.

### DESCRIPTION OF THE DRAWINGS

FIG. 1 is an XRD pattern of nano-scale ultrathin graphdiyne prepared in Embodiment 1 of the present invention;

FIG. 2 shows Raman results of the nano-scale ultrathin graphdiyne prepared in Embodiment 1 of the present invention;

FIG. 3 is an SEM image of the nano-scale ultrathin graphdiyne prepared in Embodiment 1 of the present invention;

FIG. 4 is a TEM image of the nano-scale ultrathin graphdiyne prepared in Embodiment 1 of the present invention;

FIG. 5 is a higher-resolution TEM image of the nano-scale ultrathin graphdiyne prepared in Embodiment 1 of the present invention;

FIG. 6 is an AFM image of the nano-scale ultrathin graphdiyne prepared in Embodiment 1 of the present invention;

FIG. 7 is an XRD pattern of nano-scale ultrathin hydrogen-substituted graphdiyne prepared in Embodiment 2 of the present invention;

FIG. 8 is an SEM image of the nano-scale ultrathin hydrogen-substituted graphdiyne prepared in Embodiment 2 of the present invention;

FIG. 9 is a TEM image of the nano-scale ultrathin hydrogen-substituted graphdiyne prepared in Embodiment 2 of the present invention;

FIG. 10 is a AFM image of the nano-scale ultrathin hydrogen-substituted graphdiyne prepared in Embodiment 2 of the present invention;

FIG. 11 is an SEM image of nano-scale ultrathin hydrogen-substituted graphdiyne prepared in Embodiment 3 of the present invention;

FIG. 12 is a TEM image of the nano-scale ultrathin hydrogen-substituted graphdiyne prepared in Embodiment 3 of the present invention;

FIG. 13 is an AFM image of nano-scale ultrathin graphdiyne prepared in Embodiment 4 of the present invention; and

FIG. 14 is an AFM image of nano-scale ultrathin graphdiyne prepared in Embodiment 5 of the present invention.

### DETAILED DESCRIPTION OF PREFERRED EMBODIMENTS

Specific embodiments of the present invention are provided hereinafter. The specific embodiments are merely used to further describe the present invention in detail, and are not intended to limit the scope of protection of the present invention.

### Embodiment 1

A method for preparing nano-scale ultrathin graphdiyne and a derivative thereof comprised the following steps.
(1) 50 g of sodium chloride and 2.5 g of copper acetate were mixed and ball-milled for 5 hours, and then ball-milled mixed powder was sieved with a 200-mesh sieve. The ball-milled powder was light blue.
(2) 6 g of mixed powder was put into two quartz boats, and placed in a closed heating tube furnace. In a mixed atmosphere of hydrogen and argon, the power was heated to 300° C. at a heating rate of 5° C./min, and hydrogen at a gas flow rate of 50 sccm was mixed with argon at a gas flow rate of 150 sccm. After maintaining the temperature of 300° C. for two hours, the hydrogen was stopped, the argon was kept to circulate, the system was naturally cooled to room temperature, and the powder was taken out, which was pink.
(3) 2 g of pink powder obtained in the step (2) was put into a 250 mL three-necked flask, air in the flask was replaced with an inert gas atmosphere, and magnetons were added. Subsequently, 50 mL of acetone, 5 mL of pyridine and 1 mL of tetramethylethylene diamine were injected into the system and stirred. 50 mL of acetone solution in which 30 mg of hexaalkynyl benzene was dissolved was dropwise added into the system through a constant-pressure dropping funnel, and the dropwise addition was finished within two hours. After the dropwise addition, the stirring was stopped, and the system was heated to 60° C. and maintained for 24 hours. Subsequently, the heating was stopped, and the system was naturally cooled to room temperature.
(4) The powder obtained in the step (3) was filtered, the powder was alternately washed with N,N-dimethylformamide and acetone, wherein the powder was washed with the acetone for the last time, and then the powder was naturally dried. Then, the powder was soaked with dilute hydrochloric acid for 2 days to dissolve copper species in the powder. The powder was cleaned with ultrapure water until a pH value of the system was 7, and the powder was dispersed in a small amount of deionized water, frozen with liquid nitrogen and vacuum-dried in a vacuum freeze-dryer at −55° C. to obtain final nano-scale ultrathin graphdiyne powder.

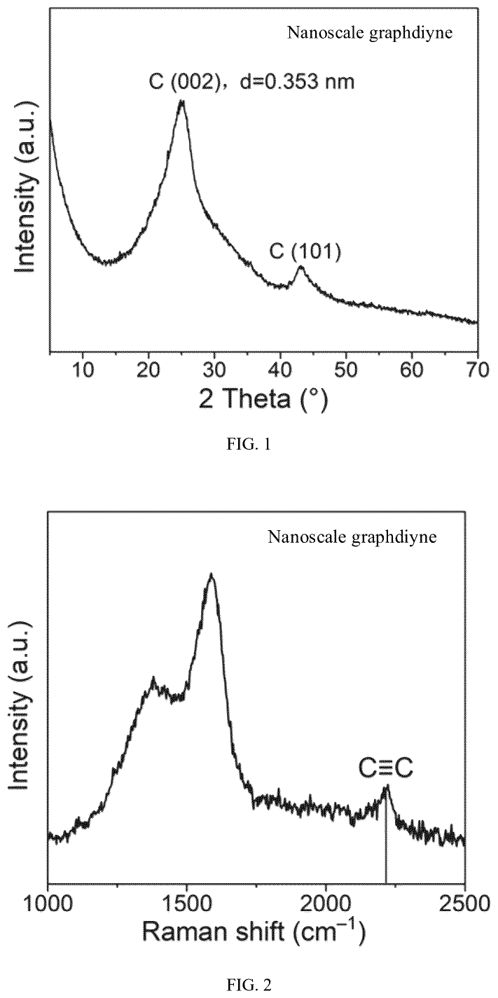

It can be seen from FIG. 1 that main diffraction peaks of XRD of the obtained nano-scale ultrathin graphdiyne powder are carbon (002) and (101) crystal planes, and an interlayer spacing is 0.353 nm.

It can be seen from FIG. 2 that there is an obvious acetylene bond signal at 2220 cm⁻¹ in Raman of the obtained nano-scale ultrathin graphdiyne powder.

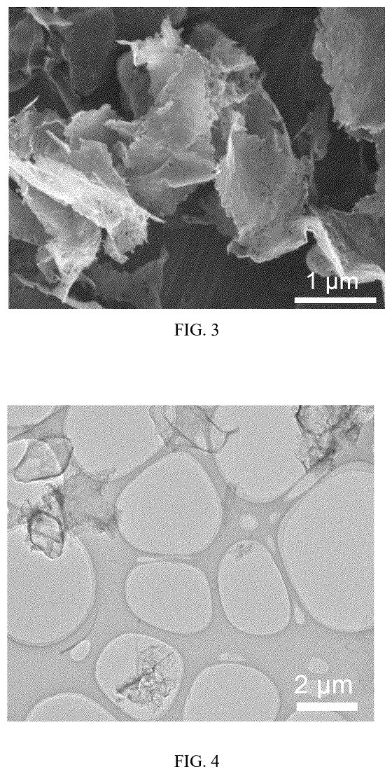

It can be seen from FIG. 3 that the obtained nano-scale graphdiyne powder is an independent nanosheet with a nano-scale thickness.

It can be seen from FIG. 4 that the obtained nano-scale graphdiyne powder is a uniform thin layer stripped from sodium chloride particles.

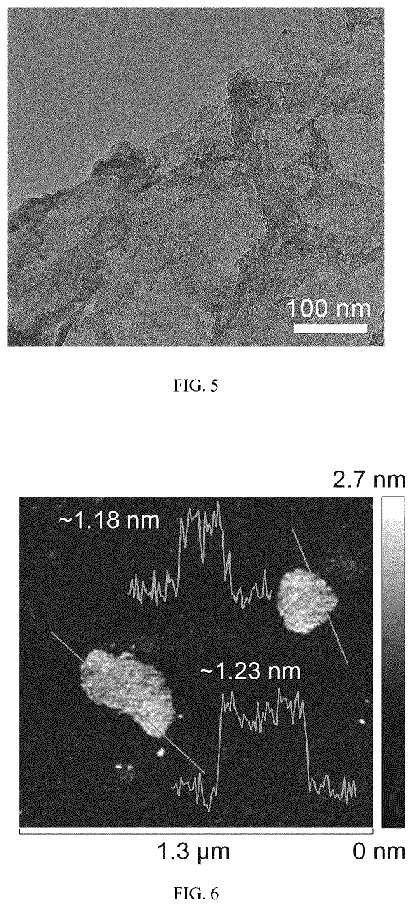

It can be seen from FIG. 5 that the obtained nano-scale graphdiyne powder is a nanosheet with a uniform thickness microscopically.

It can be seen from FIG. 6 that the obtained nano-scale graphdiyne powder has a uniform thickness of 1-2 nm.

### Embodiment 2

Embodiment 2 was different from Embodiment 1 in that: the hexaalkynyl benzene in the step (3) was changed to 1,3,5-trialkynyl benzene. Other contents were the same as those of Embodiment 1.

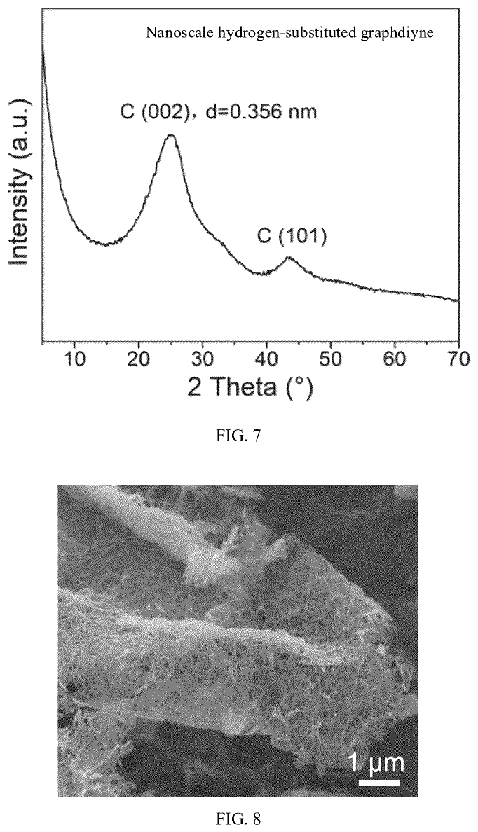

It can be seen from FIG. 7 that XRD of the obtained nano-scale hydrogen-substituted graphdiyne powder in Embodiment 2 still shows (002) and (101) crystal planes, and an interlayer spacing is 0.356 nm.

It can be seen from FIG. 8 that, when the polymerization monomer added is the 1,3,5-trialkynyl benzene, an ultrathin nanosheet formed by interweaving nanofibers may be obtained by growing.

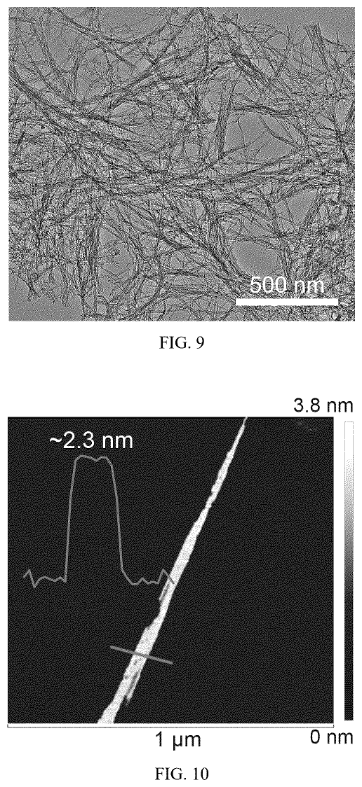

It can be seen from FIG. 9 that the obtained nano-scale hydrogen-substituted graphdiyne powder in Embodiment 2 is composed of interwoven thin-layer fibers.

It can be seen from FIG. 10 that the obtained nano-scale hydrogen-substituted graphdiyne powder in Embodiment 2 is composed of nanofibers with a thickness of about 2.3 nm.

### Embodiment 3

Embodiment 3 was different from Embodiment 2 in that: the sodium chloride in the step (1) was changed to sodium sulfate. Other contents were the same as those of Embodiment 2.

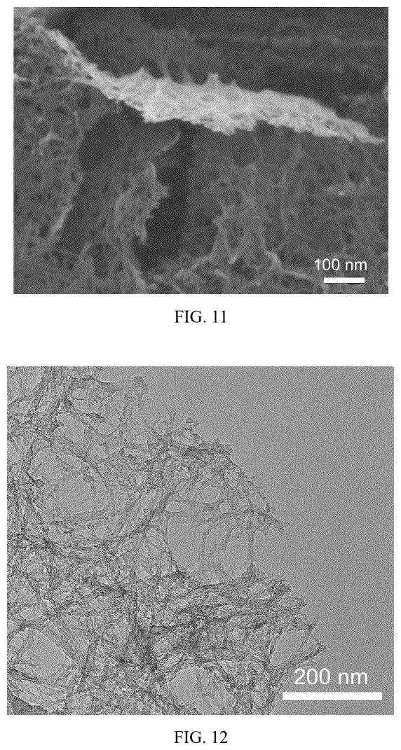

It can be seen from FIG. 11 and FIG. 12 that, when the template is changed to the sodium sulfate, the thin-layer hydrogen-substituted graphdiyne film composed of interwoven fibers can still be obtained.

### Embodiment 4

Embodiment 4 was different from Embodiment 1 in that: the mass of the hexaalkynyl benzene in the step (3) was changed to 40 mg. Other contents were the same as those of Embodiment 1.

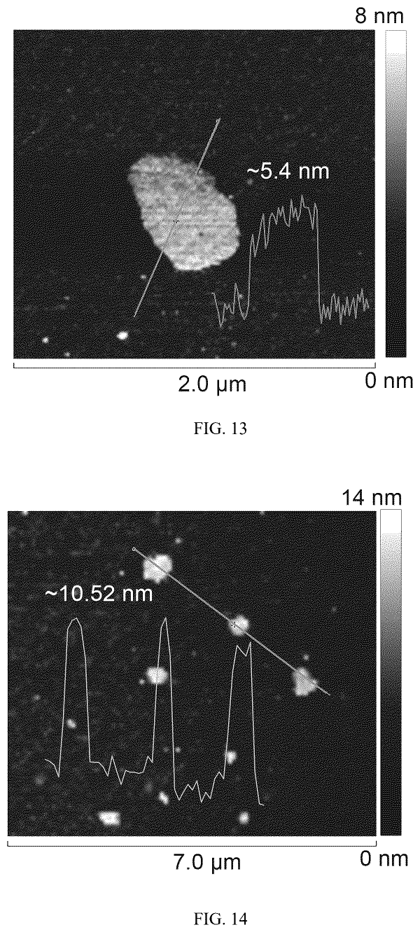

It can be seen from FIG. 13 that a thickness of the obtained nano-scale graphdiyne powder in Embodiment 4 is about 5.4 nm.

### Embodiment 5

Embodiment 5 was different from Embodiment 1 in that: the mass of the hexaalkynyl benzene in the step (3) was changed to 60 mg, and the mass of the powder sample in the step (2) was changed to 2.5 g. Other contents were the same as those of Embodiment 1.

It can be seen from FIG. 14 that a thickness of the obtained nano-scale graphdiyne powder in Embodiment 5 is about 10.52 nm.

What is not mentioned in the present invention is applicable to the prior art.

The above are only the preferred embodiments of the present invention, and it should be pointed out that those of ordinary skills in the art may further make several modifications and improvements without departing from the concept of the present invention, and these modifications and improvements all fall within the scope of protection of the present invention.

We claim:

1. A method for controllably preparing nano-scale ultrathin graphdiyne and a derivative thereof, comprising the following steps:
(1) mixing and ball-milling a substance A and a substance B to obtain mixed powder of the substance A and the substance B, and uniformly dispersing the substance A on a surface of the substance B, wherein the substance A is a copper-containing salt, and the substance B is one or more of sodium chloride, potassium chloride, sodium sulfate and potassium sulfate;
(2) putting the mixed powder into a closed heating environment, heating the mixed powder to 200-450° C. in an atmosphere of inert gas and hydrogen, maintaining hydrogen introduction and the heating temperature for 2-4 hours, and then cooling the mixed powder to room temperature;
(3) adding the mixed powder into a container, adding a solvent, then dropwise adding an acetone solution containing a monomer of graphdiyne or a derivative thereof, stirring the mixture at 50-180° C., stopping stirring after the dropwise addition, maintaining the temperature for 1-2 days, and then cooling the mixture to room temperature; and
(4) pouring out a liquid in the container after the reaction, washing the powder, then soaking the powder with dilute hydrochloric acid for 1-3 days, carrying out suction filtration with deionized water, collecting a filter cake, and freeze-drying the filter cake to obtain a nano-scale ultrathin graphdiyne film.

2. The method for controllably preparing the nano-scale ultrathin graphdiyne and the derivative thereof according to claim 1, wherein, in the step (1), a mass ratio of the substance A to the substance B is 0.5 to 20:100.

3. The method for controllably preparing the nano-scale ultrathin graphdiyne and the derivative thereof according to claim 1, wherein, in the step (1), the substance A is one or more of copper nitrate, copper chloride, copper acetate and copper sulfate, with or without water of crystallization.

4. The method for controllably preparing the nano-scale ultrathin graphdiyne and the derivative thereof according to claim 1, wherein, in the step (2), a gas flow ratio of the hydrogen to the inert gas is 1:3 to 1:1.

5. The method for controllably preparing the nano-scale ultrathin graphdiyne and the derivative thereof according to claim 1, wherein, in the step (3), a mass ratio of the powder to the monomer of the graphdiyne or the derivative thereof is 100:0.5 to 100:3.

6. The method for controllably preparing the nano-scale ultrathin graphdiyne and the derivative thereof according to claim 1, wherein, in the step (3), the monomer of the graphdiyne and the derivative thereof are one or more of hexaalkynyl benzene, 1,3,5-trialkynyl benzene and 1,3,5-triethynyl-2,4,6-trifluorobenzene.

7. The method for controllably preparing the nano-scale ultrathin graphdiyne and the derivative thereof according to claim 1, wherein, in the step (3), the solvent is a mixed solvent of acetone, pyridine and tetramethylethylene diamine prepared according to a volume ratio of 100:5:1.
